(19) United States
(12) Patent Application Publication
(10) Pub. No.: US 2021/0391622 A1
(43) Pub. Date: Dec. 16, 2021

(54) Battery and Motor Systems for Electric-Powered Vehicles

(71) Applicant: Michael L Froelich, Austin, TX (US)

(72) Inventor: Michael L Froelich, Austin, TX (US)

(21) Appl. No.: 17/460,250

(22) Filed: Aug. 29, 2021

Related U.S. Application Data
(63) Continuation-in-part of application No. 16/686,195, filed on Nov. 17, 2019, now Pat. No. 11,121,650.
Application No. 16/686,195 is a continuation-in-part of application No. 14/120,039, filed on Apr. 17, 2014, now Pat. No. 11,104,231.

(51) Int. Cl. H01M 50/249; H01M 50/204; B60L 53/80; B60L 50/60

(52) U.S. Cl. CPC H01M 50/249; B60L 50/66; B60L 53/80; H01M 50/204

(57) ABSTRACT

A system for maintaining battery cycle life for motorized battery-powered electric vehicles. Current battery-powered electric vehicles such as automobiles and trucks suffer from short cycle life of their batteries, meaning that these vehicles' batteries will become unusable well before reaching the normal useful life of combustion engine powered vehicles. Owners of vehicles using my system will enjoy vehicles with acceptable ranges, acquisition and operating costs, yet will enjoy battery lifetimes as long or as longer than the useful life of combustion engine vehicles.

### CROSS REFERENCE TO RELATED APPLICATIONS

This application is a Continuation-in-Part of U.S. patent application Ser. No. 16/686,195, filed 17 Nov. 2019, now U.S. patent Ser. No. 11/121,650, and is a Continuation-in-Part of U.S. patent application Ser. No. 14/120,039, filed 17 Aug. 2014, now U.S. patent Ser. No. 11/104,231; said patent documents being incorporated herein in entirety for all purposes by reference.

### FIELD OF THE INVENTION

The present invention relates to motorized vehicles or craft of any kind which are powered by batteries with cycle lifetimes that are diminished by cyclical discharge and recharge.

### BACKGROUND

Current all-electric vehicles are not competitive with their traditional fuel-burning, combustion-engine counterparts because they are designed to encourage their operators to use all or most of the charge of the batteries. All current dry cell, and therefore lightweight, rechargeable batteries can only be discharged and recharged, or cycled, a limited number of times before the battery's capacity to accept a charge declines and falls off to an unacceptable degree.

All vehicles today use batteries which if discharged by only 15% to 50% before recharging can be recharged tens of thousands of times. These same batteries if discharged by 100% can only be recharged between four to six hundred times, meaning only four to six hundred days of operation. Four to six hundred days of vehicle operation is well below the normal duration of use of combustion engine vehicles, and when owners of current electric vehicles begin to see the charging capacity of their batteries decline after only a few hundred days of use they will regret having purchased such a vehicle with expensive batteries which do not permit their vehicle to last as long as a combustion powered one.

However my system eliminates this problem through several feature and changes. The same batteries will enjoy a cycle life of approximately 5,000 recharges, or 5,000 days of operation, if the batteries are only discharged by 50% each time the vehicle is used.

Discharging the batteries by only 50% will reduce the range of the vehicle by that much using the same batteries, therefore more battery mass must be installed to compensate for the reduced range. This may be accompanied by using inexpensive batteries as opposed to the very expensive batteries now used by all electric vehicles. Weight is not the limiting factor in designing an electric car with battery cycle life competitive to combustion engine vehicles. The limiting factor for competitiveness is the cost of the batteries such that enough batteries can be installed in the vehicle so that only a fraction of the total charge of the battery is used.

Ideally a vehicle using my invention will have more than one set of batteries so that in addition to having acceptable, competitive range due to larger battery mass the vehicle will also be able to operate for longer distances and therefore enjoy even greater competitive range.

### SUMMARY OF THE INVENTION

The purpose of the invention is to make all electric, battery-powered vehicles out-compete combustion engine vehicles by increasing the cycle life of the batteries such that they can be operating thousands of days and therefore permit the building of an electric vehicle which can be used for over ten years of daily operation, or for hundreds of thousands of miles of operation, both mileage and age well over that of combustion engines with transmissions.

The electric vehicle has no transmission or combustion engine to wear out, only air conditioning and steering and chassis parts subject to wear. An electric vehicle with my invention will be able to be operated for years and mileage well beyond the capacity of combustion engine vehicles.

As stated above, current battery-powered vehicles possess battery systems which will cause the batteries to only be recharged a few hundred times. Purchasers of current electric vehicles will experience usable life and performances of their expensive vehicles which are much less than less-expensive combustion engine cars. This invention solves this problem.

By using a less expensive rechargeable battery, and providing more than one set of batteries for the vehicle, sufficient batteries can be installed so that the acceptable range and continuous operation is achieved by switching, or swapping, between the battery sets and utilizing no more than about 55% of the batteries' charge of each set of batteries in use.

The claimed invention differs from what currently exists. Whereas current electric vehicles use batteries that are so expensive that they can only install a few of them and therefore their owners must use the entire charge, or at least 85% of the charge, and thereby diminish their usable life, my system permits electric vehicle owners to use their vehicles continuously for over a decade without diminishing the capacity of their batteries.

The invention is an improvement on what currently exists. By running down their vehicle's batteries to less than about 45% of charge capacity owners of current electric vehicles can only recharge their batteries only a few hundred times. This means their cars will only be usable for periods less than that of combustion engine cars.

Owners of my vehicles using my system will enjoy acceptable range without using more than about 50% of the charge capacity of each set of batteries, and they may select the amount of discharge they wish to employ in normal, non-reserve conditions. An over-ride switch or control may be provided that allows the owner to draw added charge when circumstances require. The system may be applied to any and all devices using rechargeable batteries such as any type of buses, vans, trucks, automobiles, motorcycles, scooters, boats and ships, aircraft and spacecraft, toys, mobile electronic devices such as computers and telephones, radios and two-way radios, transceivers as only a few examples.

In a first embodiment of the invention, batteries which are inexpensive and encased into removable battery modules are provided in two or more sets per vehicle. While one set is in the vehicle to power it, the other set is in an external battery charger where the batteries are assisted in their cycle life preservation by being slowly recharged with a limited current over seven or more hours. To allow the owner to control how much of the batteries in the vehicle are allowed to discharge under normal operation a battery discharge limit indicator is used which is set by the owner between 45% to 60% of battery discharge depending on the range vs. battery cycle life the owner desires. If 50% is selected then the cycle life of the batteries will be between 4,500 and 5,500 recharges. Once the discharge limit indicator is set by the owner it will limit the use of the batteries to the desired point of discharge, and the batteries will not power the drivetrain of the vehicle further unless over-ridden by an over-ride switch allowing the batteries to be used in a reserve mode.

The inexpensive batteries are loaded into removable battery modules to form a set of batteries, with two or more sets of batteries per vehicle. The amount of inexpensive batteries comprising a set is sufficient of charge to power the vehicle for a maximum range of at least 200 miles at 50 miles per hour with no braking and using no air conditioning or heating, for example. The battery discharge limit indicator informs the driver how much charge remains until the batteries are discharged to a preset point between 40% to 60%, depending on the owner's choice of damage-limitation to the batteries. When the driver has reached the percentage of discharge chosen by the owner the driver changes the set of battery modules, or if unable, can over-ride the limiter by using an emergency switch to access the reserve capacity of the batteries.

The sets of batteries are interchangeable, and may be quickly swapped at a convenient time and place rather than requiring the owner to wait for recharging of the batteries in the vehicle.

The invention works in this way. The inexpensive batteries work by permitting a sufficient mass of batteries to be loaded into the vehicle, and to allow for two sets of batteries per vehicle, to permit the vehicles to be manufactured at costs so that the costs to the owner of the vehicle use is equal to or less than combustion engine vehicles. The removable battery modules permit the vehicle to be operated continuously without sitting unusable for the minimum of seven hours charging time required to charge batteries with slow current such that they are not damaged by running high current through them in fast charging times. The external battery charger permits the unused set of battery modules to be recharged while the other set is in use in the vehicle. The battery discharge limit indicator is what permits the owner to set the amount of discharge the batteries will normally endure under non-emergency conditions.

The invention is made by constructing the removable battery modules by fashioning containers into which a set of inexpensive battery cells may be placed so that their currents may be coupled to a motor or motors of the vehicle when the removable battery modules are installed in it. The vehicle can be fashioned with an electric motor or motors to propel it and the removable battery modules are installed so that the current from the inexpensive battery cells powers the vehicle. The battery discharge limit indicator can be fashioned by connecting a sensor measuring the amount of charge remaining on the battery cells to a gauge visible to the driver. An adjustment on the battery discharge limit indicator may be configured so the owner may set the amount of discharge permitted under normal conditions, and a switch or control interface may be used by the driver to over-ride the owner's settings under non-ideal circumstances in which the vehicle cannot be brought to the site of the second set of batteries in the external battery charger within the owner's set discharge limit. The external battery charger can be made by fabricating a housing into which the removable battery modules may be seated so that a current from an outside power source may be conveyed to the individual inexpensive battery cells to recharge them with a current low enough to require at least seven hours to recharge them fully.

To limit damage to the batteries from excessive discharge only inexpensive batteries and the battery discharge limit indicator are required. It is possible to increase the usable life and cycle life of the batteries or cells while keeping them permanently installed in the vehicle and recharge them using an internal recharger which operates on a current low enough to recharge them over at least seven or eight hours.

### BRIEF DESCRIPTION OF THE DRAWINGS

One or more embodiments are taught and are more readily understood by considering the drawings in association with the specification, in which:

FIG. 1 shows a vehicle containing battery module housings containing battery modules enclosed within them.

FIG. 2 shows battery modules with handles enclosed within housings from which electric cables run to power the vehicle.

FIG. 3 shows the interior of the battery module housing with its coupling and cable.

FIG. 4 shows a battery module housing in exploded view and illustrates three battery modules and their structure.

FIG. 5 shows the bottom of the battery module showing the placement of the coupling which connects the battery module and its cells to the circuit powering the vehicle.

FIG. 6 shows a discharge limit indicator as a needle dial in which one needle is movable by the owner as an adjustment to set the discharge limit while another needle reads the actual charge left on the aggregate of the battery modules in the vehicle at that time, and the over-ride switch permitting the operator to over-ride the discharge limiter and continue using the batteries under non-ideal or emergency conditions.

FIG. 7 shows the external battery charger with the placement of an individual battery module within it and the battery charger's cable extending out from it and the battery charger's cable extending out from it to an external power source.

The drawing figures are not necessarily to scale. Certain features or components herein may be shown in somewhat schematic form and some details of conventional elements may not be shown in the interest of clarity, explanation, and conciseness. The drawing figures are part of the specification, written description and teachings disclosed here.

### DETAILED DESCRIPTION OF THE INVENTION

The present invention now will be described more fully with reference to the accompanying drawings, in which some examples of embodiments of the inventions are shown. Indeed, these inventions may be embodied in many different forms and should not be constructed as limited to the embodiments set forth herein; rather, these embodiments are provided by way of example so that this disclosure will satisfy applicable legal requirements.

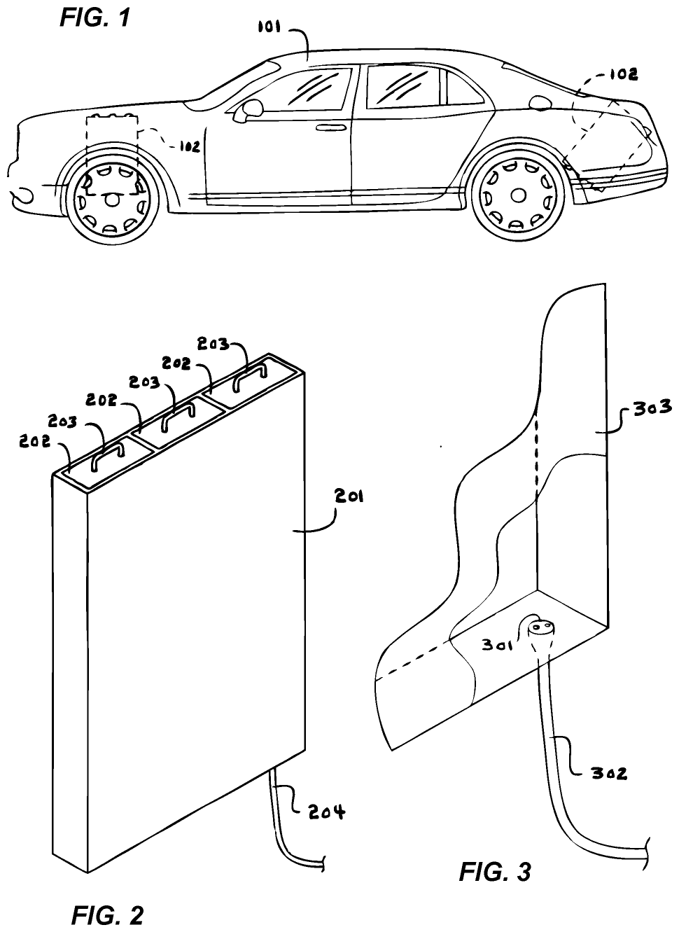

FIG. 1 illustrates a vehicle loaded with battery modules as seen from the side, with 101 being the vehicle body and 102 being battery module housings into which sets of individual battery modules are placed.

This invention contains removable battery modules which contain the individual batteries which are the power source for the motors of the vehicles. Each vehicle is equipped with multiple sets of inexpensive battery modules so that when the vehicle has been operated to the desired discharge limit that the battery modules can be removed and the alternate set installed. While a first set is in the vehicle, a second battery set is in an external battery charger where the battery cells can be recharged slowly so as to not damage them. Alternatively, the power supply may be configured to receive two or more swappable battery modules and the control system may be configured to discharge a first battery module to the discharge limit before causing power to be drawn from a second battery module, for example. In another embodiment, the control system may be powered by a swappable battery module that is independent from the swappable battery module powering the motor or motors.

Currently-available electric battery-powered vehicles are designed such that the operator is encouraged to use all or more than 50% of the vehicles' batteries' charge. However, doing so damages the batteries such that they will only recharge again for a few hundred recharges, particularly if fast recharging is used. Any electric vehicle with batteries which only last for a few hundred days of operation will be of a useful life shorter in duration than that of combustion engine powered vehicles.

In order for electric battery powered vehicles to enjoy useful lifetimes comparable to, or in excess of, combustion engine vehicles, their batteries must be discharged by only a fraction of their total capacity. By discharging the batteries by only a fraction of their capacity each time the vehicle is used, and by using mild recharging conditions, the batteries will enjoy a cycle life of thousands rather than hundreds of days of use.

The invention permits the batteries of all-electric vehicles to last for thousands of days of daily use by limiting the amount they are discharged in normal, non-reserve operation. This invention permits the owners of all-electric vehicles to select the amount of discharge of their batteries in normal, non-reserve use, and therefore to choose between longer life of their batteries and normal, non-reserve range of their vehicles. A variety of rechargeable batteries known in the art may be used. Swapping of batteries permits trickle charging, which reduces the formation of dendrites that have been associated with battery fires caused by fast charging and extended discharge below about 45-50% of capacity. Swappable battery modules are recharged under mild conditions that favor extended battery life, typically in an external recharger as described below (FIG. 7).

These battery systems may be coupled to one or more motors distributed in the vehicle chassis as described in U.S. patent application Ser. No. 16/686,195, which is incorporated here in full by reference for all that it teaches. Battery sets may be coupled to a plurality of motors such that multiple motors are engaged when higher torque is desired, and fewer motors are engaged when performance can be reduced in favor of extended range and improved battery life, for example. The motors may be direct current motors that operate with greater efficiency than obtainable with an AC motor coupled to an expensive inverter package, for example. Electric vehicles having a combination of sets of inexpensive rechargeable batteries and multiple direct current motors both reduces the initial costs of the electric vehicle, and, by establishing a system for limiting battery discharge (with swappable battery sets), also achieves significant improvements in reducing operating costs over the life of the vehicle. The motors may be electrically connected to the battery modules under control of an operator.

FIG. 2 is a perspective drawing of a set of three battery modules fitted into a housing residing inside a vehicle, with 201 being the housing body, 202 being the individual battery modules, 203 being the handles by which the battery modules are moved from place to place such as fitted into the housing, and 204 being a connecting electric cable which conveys current from the battery through the housing and outward from the housing to the power requirements of the vehicles, principally the drivetrain.

FIG. 3 is a cutaway perspective drawing of the interior of the battery module housing in which 301 is a coupling which connects a battery module to the housing from which current is conveyed outside the housing to a motor or motors via cable 302, in which a housing body represented by 303.

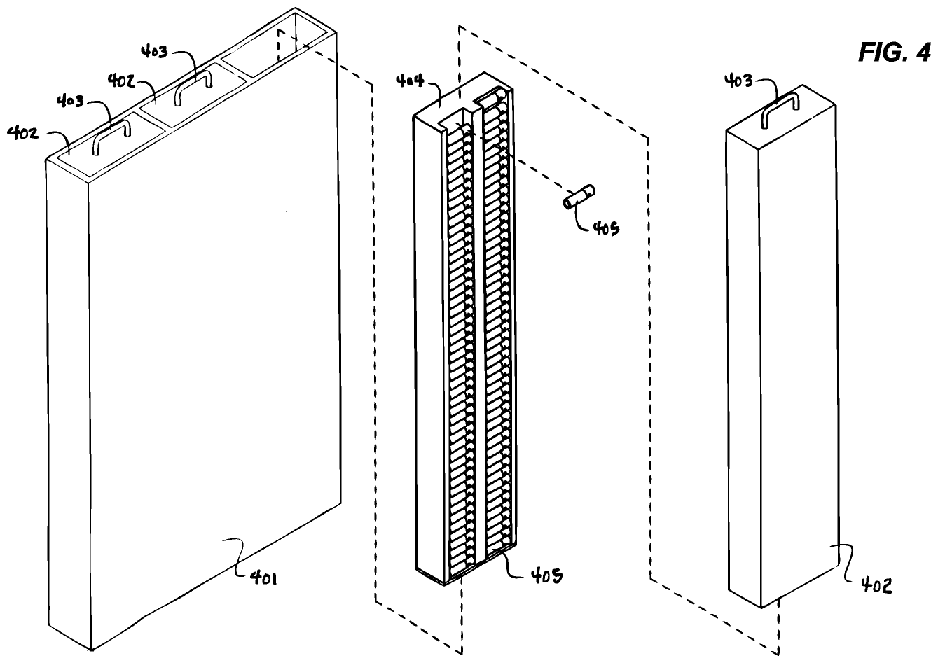

FIG. 4 is a perspective drawing showing an exploded view (dashed lines) of the battery module housing and battery modules in the housing. Battery module housing 401 is the housing body, 402 being the individual battery modules fitted into the body, and 403 being the handles by which the battery modules are moved.

The center panel of FIG. 4 shows the interior structure of the battery module which is found inside of a battery module, in which 404 is the structural framework which holds individual battery cells 405 and conveys their currents through the battery module via an electrical coupling in framework 404.

The leftmost panel of FIG. 4 shows housing 401 for three battery modules in which one battery module 403 is removed (dashed line). The right panel shows battery module 403 in which the internal structure is fully assembled and as is fitted into the battery module housing when the battery module powers the vehicle.

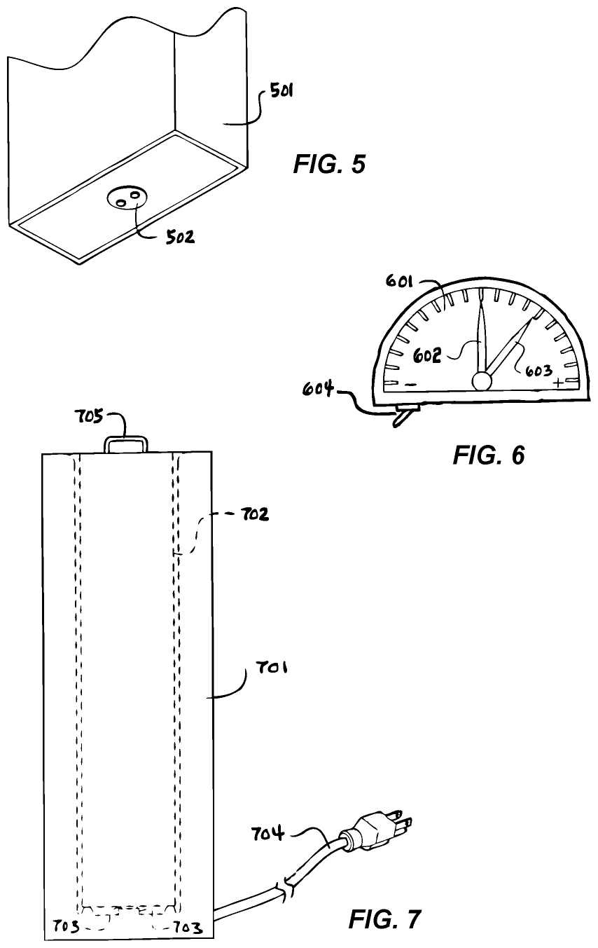

FIG. 5 is a perspective drawing of the bottom of a battery module 501 and showing the placement of a coupling 502 which conveys current to the framework inside in which resides individual cells.

FIG. 6 illustrates a discharge limit indicator in the form of a needle dial with a measured dial face 601 so that the vehicle operator can see the amount of charge remaining on the aggregate of the battery module set or sets installed within the vehicle as a percentage of the total charge capacity of the battery module set or sets in aggregate. 602 represents a movable needle which is the control setting for the discharge limit indicator in which the setting has been set by the vehicle's owner at the mid-point of the aggregate charge of an installed battery module set, or 50% of charging capacity. 603 represents a gauge needle which reads the actual remaining charge left on the aggregate of the battery modules installed in the vehicle and coupled to the power train, and is reading that the remaining charge is at 75% of total charge capacity as shown here. The gauge dial reads left to right with a minus sign on the left of the dial and a positive sign on the right of the dial. 604 represents an over-ride switch or control which may be used by the vehicle operator so that the battery modules do not automatically disconnect from the drivetrain of the vehicle once their aggregate charge has reached 50% of full charge capacity as indicated by the setting of the movable needle. In this way everything below 50% of full charge is considered a capacity reserve (i.e., only to be used in non-ideal conditions) so that the useful life of the batteries will be maintained through thousands of recharging cycles under mild conditions.

The display may include a control interface for setting the discharge limit and for over-riding the limit if necessary. For example, switch 604 may be a manual over-ride switch and is representative of a control interface as would be used when circumstances dictate the need to over-ride the preferred or optimal discharge limit.

The system will include a sensor for measuring battery voltage and a battery discharge monitoring apparatus that measures current draw. The sensor and battery discharge monitor are coupled during use with a processor having instructions for calculating and displaying the remaining charge in a battery module during operation of the vehicle.

FIG. 7 illustrates an external battery charger into which a set of battery modules not presently in the vehicle is placed so that the batteries can be recharged under mild conditions, such as slowly recharged over perhaps seven or eight hours of low current, to preserve the cycle life of the batteries. The external battery charger outside is 701, while 702 (dashed line) is an interior depiction of the placement of an individual battery module with its handle 705 so it may be placed within the charger and removed from it. 703 is a coupling inside the charger which connects to the coupling inside the battery module so current from the outside charger may be conveyed to the battery module and distributed to the individual cells within it. 704 is an electric cable connecting the external battery charger to an outside power source.

Many modifications and other embodiments of the innovation set forth herein will come to mind to one skilled in the art to which these inventions pertain having the benefit of the teachings presented in the foregoing descriptions and the associated drawings. Therefore, it is to be understood that the inventions are not limited to the specific examples of the embodiments disclosed and that modifications and other embodiments are intended to be included within the scope of the appended claims. Although specific terms are employed herein, they are used in a generic and descriptive sense only and not for the purpose of limitation.

I claim:

1. A battery system for use with a motorized electric vehicle, which comprises:
a plurality of swappable battery modules, each battery module having a set of rechargeable batteries in a portable housing configured for battery module swapping;
a first battery module of the plurality of swappable battery modules that is electrically connectable to a motor or motors of the electric vehicle;
a sensor unit configured to detect discharge of the first battery module when the electric vehicle is in operation, and an operator display that displays the remaining charge in the first battery module and a discharge limit during operation of the vehicle;
a control system that defines the discharge limit and triggers disconnection of the first battery module if the discharge limit is reached, wherein the control system includes a user over-ride control that disables disconnection of the first battery module; and,
an external charger configured to receive one or more partially discharged battery modules, and to perform a recharge cycle under mild conditions that minimize degradation of battery cycle lifetime.

2. The battery system of claim 1, wherein the user over-ride control is a manual switch.

3. The battery system of claim 1, wherein the first battery module is manually exchangeable with a second battery module when the first battery module has reached the defined discharge limit.

4. The battery system of claim 1, wherein the electric vehicle is configured to receive two or more swappable battery modules and the control system is configured to discharge the first battery module to the discharge limit before causing power to be drawn from a second battery module.

5. The battery system of claim 1, wherein each swappable battery module includes a portable casing, a set of rechargeable battery cells, an electrical coupling for connecting the battery module to the motor or motors of the electric vehicle and for discharging and recharging the battery cells, and a handle for portably swapping the battery modules.

6. The battery system of claim 1, wherein the sensor unit comprises a battery voltage sensor and a battery discharge monitor.

7. The battery system of claim 6, wherein the sensor unit is coupled during use with a processor having instructions to calculate and display to an operator the remaining charge in a battery module electrically connected to a motor or motors of the electric vehicle.

8. An electric vehicle, which comprises:
a plurality of swappable battery modules, each battery module having a set of rechargeable batteries in a portable housing configured for battery module swapping;
a first battery module of the plurality of swappable battery modules that is electrically connectable to a motor or motors of the electric vehicle;
a sensor unit configured to detect discharge of the first battery module when the electric vehicle is in operation, and an operator display that displays the remaining charge in the first battery module and a discharge limit during operation of the vehicle; and,
a control system that defines the discharge limit and triggers disconnection of the first battery module if the discharge limit is reached, wherein the control system includes a user over-ride control that disables disconnection of the first battery module.

9. The electric vehicle of claim 8, which comprises a plurality of direct current motors that supply torque to propel the vehicle, wherein the motors are powered by the first battery modules.

10. The electric vehicle of claim 8, wherein the control system operates to disconnect the first battery module when its discharge limit is exceeded and to connect a second battery module while the vehicle is in operation.

11. The electric vehicle of claim 8, wherein the battery modules that have reached their discharge limit are configured to be manually removed from the vehicle for external recharging and manually replaced by fully charged battery modules.

12. The electric vehicle of claim 8, wherein each swappable battery module includes a portable casing, a set of rechargeable battery cells, an electrical coupling for connecting the battery module to the motor or motors of the electric vehicle and for discharging and recharging the battery cells, and a handle for portably swapping the battery modules.

13. The electric vehicle of claim 8, wherein the sensor unit comprises a battery voltage sensor and a battery discharge monitor.

14. The electric vehicle of claim 13, wherein the sensor unit is coupled during use with a processor having instructions to calculate and display the remaining charge in the first battery module.

15. The electric vehicle of claim 9, wherein a first direct current motor is powered by the first battery module, and the control system is powered by a second battery module.

16. The electric vehicle of claim 8, wherein the user over-ride control is a manual control switch.

17. The electric vehicle of claim 8, wherein the operator display includes a needle dial that has at least:
a dial face with markings indicating remaining charge;
a first needle acting as the indicator, which when pointing to a first marking indicates measured charge remaining in the battery module or modules that power the vehicle;
a second needle acting as a manual adjustment, which is moved manually to adjust the discharge limit, the discharge limit being set by a second marking the second needle points to, wherein the control system disconnects the battery module or modules from the motor or motors when the first marking is lower than the second marking.

18. The electric vehicle of claim 8, wherein the operator display is a digital display.

19. The electric vehicle of claim 8, wherein each of the plurality of battery modules further including a plurality of battery cells placed in a frame, the plurality of battery cells being connected as a voltaic pile, and each of the plurality of battery cells is independently removable from the frame.

20. The electric vehicle of claim 8, the battery modules comprising lightweight exchangeably replaceable battery trays disposed under a hood or trunk of the vehicle.

21. The electric vehicle of claim 9, wherein the motors are electrically connectable to one or more of the swappable battery modules under control of an operator.
